(19) United States
(12) Patent Application Publication
(10) Pub. No.: US 2019/0034595 A1
(43) Pub. Date: Jan. 31, 2019

(54) GENERATING ROBUST SYMPTOM ONSET INDICATORS

(71) Applicant: International Business Machines Corporation, Armonk, NY (US)

(72) Inventors: Zhaonan Sun, Elmsford, NY (US); Soumya Ghosh, Boston, MA (US); Ying Li, Fort Lee, NJ (US); Yu Cheng, Ossining, NY (US); Jianying Hu, Bronx, NY (US)

(21) Appl. No.: 15/661,591

(22) Filed: Jul. 27, 2017

(51) Int. Cl. G06F 19/00

(52) U.S. Cl. CPC G06F 19/3431; G06F 19/3437; G06F 19/322

(57) ABSTRACT

Embodiments describing an approach to receiving patient registry data and creating at least one control model based on the patient registry data. Transforming patient registry data into at least one prediction confident interval based on the at least one control model. Transforming the at least one prediction confident interval into at least one robust assessment score, and outputting the at least one robust assessment score for measuring disease progression indicators.

### BACKGROUND OF THE INVENTION

The present invention relates generally to the field of disease progression indicators, and more particularly to generating robust disease progression indicators based on patient registry data.

Patient registries are organized systems that use observational study methods to collect data for specific purposes, e.g., to observe the natural history of disease, to monitor safety, to measure quality of care, and to assess the clinical and cost burden of illness. Measurements from clinical assessments are collected in a patient registry for tracking the progression of a target disease. In current practice, for each clinical assessment pertinent to disease progression (DP), one or multiple threshold values are used as indicators of DP. The threshold values are decided based on observations and experiences of disease domain experts, therefore could suffer from biases induced by subjective selection criteria. Data-driven methods are needed to objectively determine the threshold values, or to support existing threshold values. In addition, measurements generated from clinical assessments can be affected by factors not associated with DP, e.g., natural aging process, education level or marital status. Therefore, raw measurements may not be effective for monitoring the progression of a targeted disease.

### SUMMARY

According to one embodiment of the present invention, a computer-implemented method for generating one or more robust assessment scores based on patient registry data for disease progression indicator measurements. The computer-implemented method includes receiving, by one or more processors, patient registry data. Creating, by the one or more processors, at least one control model based on the patient registry data. Transforming, by the one or more processors, patient registry data into at least one prediction confident interval based on the at least one control model. Transforming, by the one or more processors, the at least one prediction confident interval into at least one robust assessment score, and outputting, by the one or more processors, the at least one robust assessment score for measuring disease progression indicators.

According to another embodiment of the present invention, a computer system comprising: one or more computer processors; one or more computer readable storage devices; program instructions stored on the one or more computer readable storage devices for execution by at least one of the one or more computer processors. The stored program instructions including program instructions to receive patient registry data. Program instructions to create at least one control model based on the patient registry data. Program instructions to transform patient registry data into at least one prediction confident interval based on the at least one control model. Program instructions to transform the at least one prediction confident interval into at least one robust assessment score, and program instructions to output the at least one robust assessment score for measuring disease progression indicators.

According to another embodiment of the present invention, a computer program product for generating a robust assessment score based on patient registry data for disease progression indicator measurement, the computer program product comprising: one or more computer readable storage devices and program instructions stored on the one or more computer readable storage devices. The stored program instructions include program instructions to receive patient registry data. Program instructions to create at least one control model based on the patient registry data. Program instructions to transform patient registry data into at least one prediction confident interval based on the at least one control model. Program instructions to transform the at least one prediction confident interval into at least one robust assessment score, and program instructions to output the at least one robust assessment score for measuring disease progression indicators.

### BRIEF DESCRIPTION OF THE DRAWINGS

FIG. 1 is a functional block diagram illustrating a distributed data processing environment, in accordance with an embodiment of the present invention;

FIG. 2 illustrates operational steps of disease progression component, on a client device within the distributed data processing environment of FIG. 1, in accordance with an embodiment of the present invention;

FIG. 3 illustrates a graph depicting an embodiment of the present invention;

FIG. 4 illustrates a graph depicting an embodiment of the present invention;

FIG. 5A and 5B illustrates graphs depicting an embodiment of the present invention; and

FIG. 6 depicts a block diagram of components of the server computer executing the calibration component within the distributed data processing environment of FIG. 1, in accordance with an embodiment of the present invention.

### DETAILED DESCRIPTION

Currently, clinical assessments used in patient registries (i.e., disease registry) for tracking disease progressions (DP) are designed and selected by a disease domain expert based on their disease domain knowledge. A disease registry can be an organized system that uses observational study methods to collect uniform data to evaluate specified outcomes for a population defined by a disease of interest, condition, or exposure, and that serves one or more predetermined scientific, clinical, and/or policy purposes, which can differ from data collected in Electronic Health Record (EHR). The research of understanding a particular disease belongs to the secondary use of data; the data collected in registries serve as a primary source to study the target disease. As a primary source, the registry data usually involves data generated from known and comprehensive clinical assessments for the target disease, and therefore a disease registry can be a powerful tool to observe the course of the disease, to understand variations in treatment and outcomes, to examine factors that influence prognosis and quality of life, and to assess the clinical cost and quality of care. The natural course of a disease can be characterized by the onset and progression of symptoms.

Measures from clinical assessments are collected in a disease registry (i.e. registry data) for tracking various symptoms of a target disease. However, such measures can be biased since they not only can be affected by the progression of the target disease, but also can be influenced by non-disease-related factors (e.g. selection bias, clinical instrument sensitivity and participant compliance). Moreover, for a symptom of interest, its onset and progression indicator are decided by threshold values of recorded clinical measures. Such threshold values are currently determined based on evaluation of measures recorded in comparable historical studies or by a disease domain expert, and are applied to all participants in a registry. Consequently, these threshold values do not take individual variations into account. To address the aforementioned issues, data-driven methods are needed to generate robust (i.e., less biased) and personalized symptom onset indicators, and as a result, a better understanding of the natural course of a targeted disease.

A disease registry can include only people with a disease of interest, or it can also include one or more comparison groups for which data are collected using the same methods during the same period. Hereinafter, we refer to patients with a disease of interest as case participants, while patients in the comparison group who are not at risk are labeled control participants. Control participants can share some similar traits or can be exposed to similar environmental factors as case participants. Embodiments of the present invention, can use control participants in a disease registry to adjust the biases inherited in the raw clinical measurements among case participants. The biases are caused by non-disease-related factors such as natural aging process, education level and marital status. For example, Huntington's Disease (HD) is an autosomal dominant fully-penetrant neurodegenerative disorder, which is caused by an abnormal expanded trinucleotide, cytosine-adenine-guanine (CAG), repeat in the Huntingtin (HTT) gene. Owing to its monogenic nature, predictive genetic testing can determine whether the disease will manifest in an individual. Among genetically confirmed HD patients, a clinical diagnosis of HD is typically made when an individual exhibits overt, otherwise unexplained extrapyramidal movement disorder. While motoring, impairment is currently the primary indicator of clinical onset, cognitive and certain behavioral disorders are also known to surface years before dysfunctional motor onset. As such, clinical measurements along these dimensions are also important for understanding the progression of the disease. Functional assessments are important in measuring overall quality of life of individuals with HD and prove useful for a descriptive characterization of HD progression. In various embodiments, control participants can be aggregated to form control cohorts.

In recent years, several large-scale observational studies have been conducted in HD gene expansion carriers (HDGECs) with the hope to understand the natural history and pathophysiology of the disease. A diverse range of clinical assessments have been designed in HD observational studies to record the triad of motor, cognitive/behavioral, and functional symptoms of HD. While accessibility to a wide range of clinical assessments from these domains has helped gain insightful information about the natural history of HD, these clinical assessments are often influenced by factors other than HD disease status and progression. For example, natural aging processes are especially known to affect participants' cognitive and functional abilities. Therefore, absolute changes in most cognitive and functional assessment scores can be attributed to multiple factors including both HD disease progression and the natural aging process, rendering assessment scores less robust (i.e., more biased) for tracking disease progression. Onset of new symptoms is useful in characterizing the course of HD. Certain clinical measures collected have predefined thresholds to indicate clinical diagnosis. For example, a Diagnostic Confidence Level (DCL) of 4 is often used to indicate 99% confidence of motor onset, thereby leading to a confirmed diagnosis of HD onset. However, other measures (e.g. the Symbol Digit Modalities Test (SDMT) score, which is used to assess cognitive abilities) do not have clearly defined thresholds for disease onset. Embodiments of the present invention can improve the art by generating more robust (i.e., less biased) and personalized symptom onset indicators, which in turn results in better understanding of the natural course of a target disease.

Furthermore, one or multiple threshold values are used to divide a target disease into different states and/or stages. Values fall from one side of a threshold value to the other to indicate the progression of the disease. The threshold values are determined based on experiences and observations of a small group of experts. Embodiments of the present invention generate robust clinical measurements based on existing clinical measures from patient registry data. In various embodiments of the present invention, the value signs for the robust clinical measurements can be negative or positive, improving the art of disease progression by providing researchers a clear data-driven threshold value. The value zero (0) serves as a natural threshold value and can be used as a DP indicator. Embodiments of the present invention can use raw measurements and/or data from a patient registry which uses case-control design. Embodiments of the present invention use a two-prong approach, which can improve the art and field of disease progressions (DP), 1) alleviate systematic biases in raw clinical measures and generate measures that are more robust for monitoring DP; and 2) provide data-driven threshold values to determine the progression of the target disease.

More specifically, embodiments of the present invention can provide a predictive model that can create on control participants to predict a clinical measure of interest. The model is referred to as the control model. The control model is used as the pivot to remove system biases caused by factors not related to DP, such factors could include individual variation, natural aging, education level, etc. The resulting measure is more robust for indicating DP. In various embodiments of the present invention, one robust clinical measure can be generated from each raw clinical measure. The clinical meaning of a robust clinical measurement is associated with the clinical meaning of the raw assessments. Multiple robust clinical measures can provide a holistic view of the progression of the target disease, improving the art and providing research benefits. In various embodiments of the present invention, signs of the robust clinical measure indicate whether the status/symptom of a case participant can be distinguished from the control cohort. For example, zero serves as a natural cut-off point for determining whether the case participant's disease status has changed, or whether there is an onset of a new symptom/manifestation. Embodiments of the present invention improve the art of clinical measurements and DP. More specifically, embodiments of the present invention can generate a robust SDMT score without bias by removing interfering factors.

The use of patient registry and/or disease registry throughout this application are interchangeable and carry the same meaning.

Implementation of embodiments of the invention may take a variety of forms, and exemplary implementation details are discussed subsequently with reference to the Figures.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It can also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations can be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

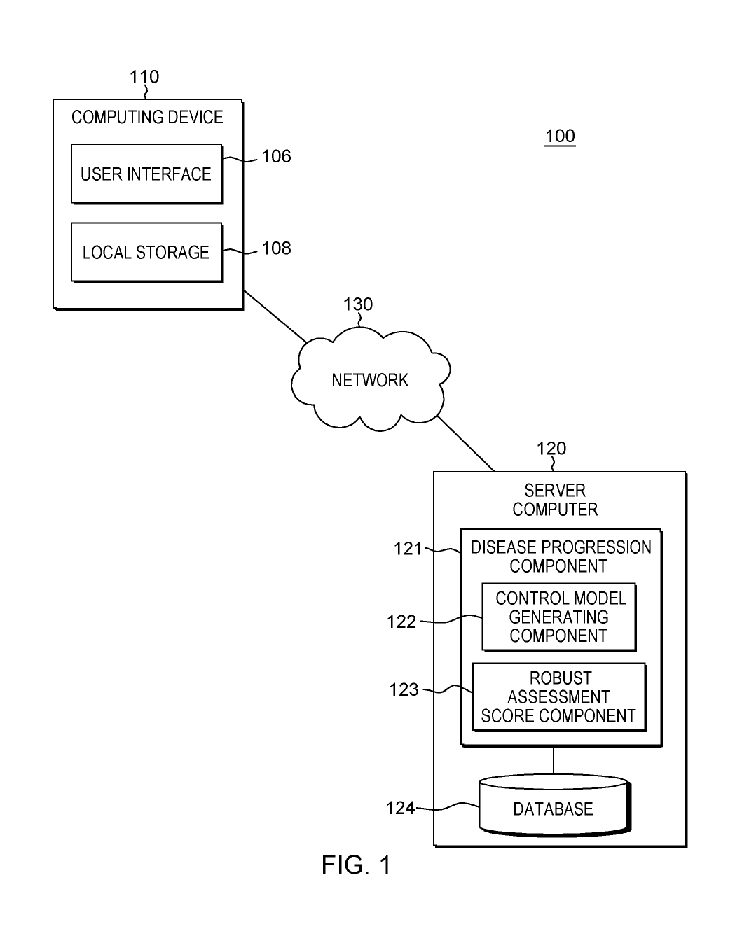

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments can be implemented. Many modifications to the depicted environment can be made by those skilled in the art without departing from the scope of the invention as recited by the claims.

Distributed data processing environment 100 includes computing device 110 and server computer 120, interconnected over network 130. Network 130 can be, for example, a telecommunications network, a local area network (LAN), a wide area network (WAN), such as the Internet, or a combination of the three, and can include wired, wireless, or fiber optic connections. Network 130 can include one or more wired and/or wireless networks that are capable of receiving and transmitting data, voice, and/or video signals, including multimedia signals that include voice, data, and video information. In general, network 130 can be any combination of connections and protocols that will support communications between computing device 110 and server computer 120, and other computing devices (not shown in FIG. 1) within distributed data processing environment 100.

In various embodiments, computing device 110 can be, but is not limited to, a standalone device, a server, a laptop computer, a tablet computer, a netbook computer, a personal computer (PC), a smart phone, a desktop computer, a smart television, a smart watch, any programmable electronic computing device capable of communicating with various components and devices within distributed data processing environment 100, via network 102 or any combination therein. In general, computing device 110 are representative of any programmable mobile device or a combination of programmable mobile devices capable of executing machine-readable program instructions and communicating with users of other mobile devices via network 130 and/or capable of executing machine-readable program instructions and communicating with server computer 120. In other embodiments, computing device 110 can represent any programmable electronic computing device or combination of programmable electronic computing devices capable of executing machine readable program instructions, manipulating executable machine readable instructions, and communicating with server computer 120 and other computing devices (not shown) within distributed data processing environment 100 via a network, such as network 130. Computing device 110 includes an instance of user interface 106. Computing device 110 and user interface 106 allow a user to interact with disease progression component 121 in various ways, such as sending program instructions, receiving messages, sending data, inputting data, editing data, correcting data and/or receiving data.

User interface 106 provides an interface to disease progression component 121 on server computer 120 for a user of computing device 110. In one embodiment, user interface 106 can be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 can also be mobile application software that provides an interface between a user of computing device 110 and server computer 120. Mobile application software, or an “app,” is a computer program designed to run on smart phones, tablet computers and other mobile devices. In an embodiment, user interface 106 enables the user of computing device 110 to send data, input data, edit data, correct data and/or receive data.

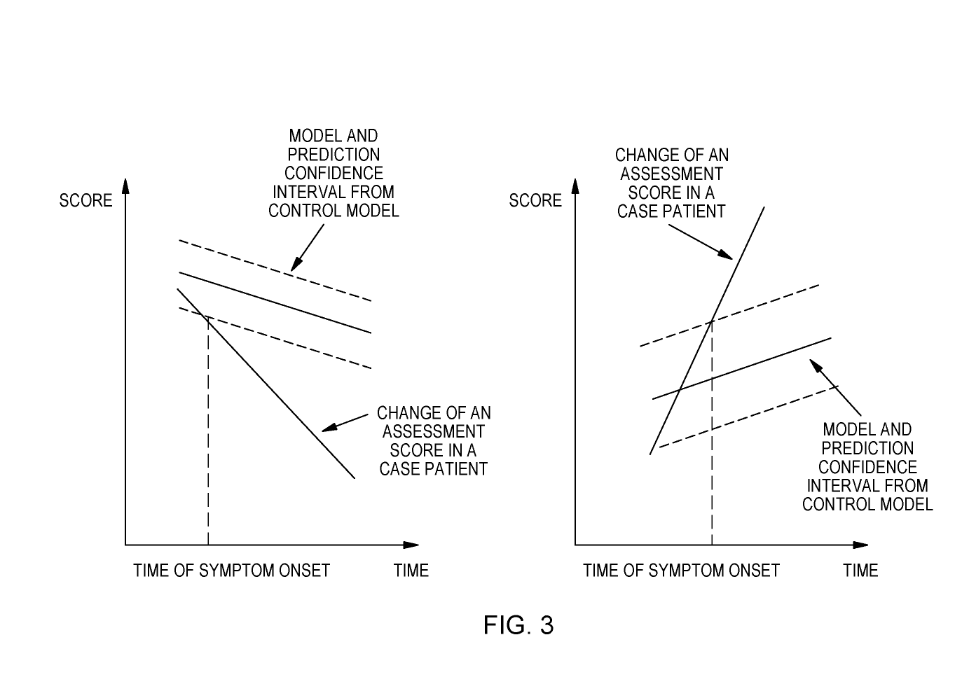

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any other programmable electronic device capable of communicating with computing device 110 and other computing devices (not shown) within distributed data processing environment 100 via network 130. In another embodiment, server computer 120 represents a computing system utilizing clustered computers and components (e.g., database server computers, application server computers, etc.) that act as a single pool of seamless resources when accessed within distributed data processing environment 100. Server computer 120 includes disease progression component 121 and database 124. Server computer 120 can include internal and external hardware components, as depicted and described in further detail with respect to FIG. 3.

Database 124 and local storage 108 can be a data repository and/or a database that can be written to and read by one or a combination of disease progression component 110, server computer 120 and/or computing device 110. In the depicted embodiment, database 124 resides on server computer 120. In another embodiment, database 124 can reside elsewhere within distributed data processing environment 100 provided coverage assessment program 110 has access to database 124. A database is an organized collection of data. Database 124 and/or local storage 108 can be implemented with any type of storage device capable of storing data and configuration files that can be accessed and utilized by server computer 120, such as a database server, a hard disk drive, or a flash memory. In other embodiments, database 124 and/or local storage can be hard drives, memory cards, computer output to laser disc (cold storage), and/or any form of data storage known in the art. In various embodiments, database 124 and/or local storage 108 can be a disease registry, a patient registry, and/or any registry and/or database capable of storing patient and/or medical data known in the art. In various embodiments, disease progression component 122 can access database 124 and/or local storage 108 to retrieve patient registry data. Patient registry data can be, but is not limited to, age, gender, heritage, language, social cues, demographic, occupation, medical history, blood type, patient medical records, pain thresholds, geographical region, psychological level (i.e., mental fitness), nationality, family medical history, genotype of a patient and/or disease, phenotypical characteristics of a disease, genealogy of a patient and/or disease, natural history data of a disease and/or patient, natural history data of a diseases mutation carries, disease symptoms, disease and/or illness characteristics and/or any other form of medical and/or disease data known in the art. The term disease can be synonymous with the term illness.

In an exemplary embodiment, disease progression component 121 is housed on server computer 120. In some embodiments, disease progression component 121 can be housed on computing device 110. In other embodiments, disease progression component 121 can be a standalone device and/or housed on a separate component (computing device and/or server computer) not depicted in FIG. 1. In various embodiments, disease progression component 121 can generate a robust score(s) based on raw data from a patient registry. Raw assessment scores can be influenced by both disease-related and non-disease-related factors. While influence of the disease-related factors on these assessment scores is desirable, influence of non-disease-related factors on these scores can result in misleading follow-up analysis and conclusions.

In general, the proposed procedure is to utilize the control cohort to evaluate the effects of non-disease-related factors on an assessment score of interest. In turn, in various embodiments, disease progression component 121 can then produce a predicted control value of the assessment score for a case participant based on the control-based model. The predicted control value gives an estimate of what the expected assessment score for a hypothetical control participant with similar characteristics as the case participant. In some embodiments, disease progression component 121 can remove the effects of non-disease-related factors by subtracting the predicted control value from the observed value, resulting in a more robust data set, in which better reflects the effects of the targeted disease. The onset of a new symptom (e.g. cognitive impairment) is defined to be the critical point at which a case participant exhibits significant difference from control participants. Comparing the observed assessment scores with the distributions of the predicted control values could lead to personalized symptom onset indicators.

In various embodiments, control model generating component 122 and robust assessment score component 123 can be subcomponents of disease progression component 121. In the exemplary embodiment, control model generating component 122 and/or robust assessment score component 123 are house on server computer 120. In other embodiments, control model generating component 122 and/or robust assessment score component 123 can be housed on computing device 110, network 130, and/or a third-party computing device and/or server computer not depicted in FIG. 1. Generally, control model generating component 122 and/or robust assessment score component 123 may be house anywhere in environment 100, as long as they remain a subcomponent of disease progression component 121.

In various embodiments, disease progression component 121 can generate multiple robust clinical measures through checking missing values, to determine if there are missing values in the data, and perform imputation to generate multiple sets of complete data sets. In various embodiments, for each imputed dataset, control model component 122 can create/generate one or more models for the target assessment with participants' characteristics, using control participants only. The one or more generated model is referred to as the control model for the imputed dataset. In various embodiments, for each imputed dataset, control model component 122 can generate predicted control values and prediction confidence intervals for HDGEC based on the generated one or more control models. In various embodiments, for each imputed dataset, robust assessment score component 123 can generate/output one or more robust assessment score for the target assessment scores. In various embodiments, robust assessment score component 123 can calculate the robust assessment score by subtracting the lower and/or upper bound of the predicted control value (PCI) from the observed value. See FIG. 3. (5) disease progression component 121 can aggregate the robust assessment scores from multiple imputed datasets. If there is no missing values in the data, steps (2)-(4) will be performed on the observed data set, and step (5) will no longer be needed.

FIG. 3 illustrates how robust assessment score component 123 can calculate and/or generate the robust assessment score. If the raw assessment score decreases with time (left panel of FIG. 3), the difference between the observed value and the lower bound of the PCI is used as the robust assessment score, as shown above in FIG. 3. If the raw assessment score increases with time (right panel of FIG. 3), then the difference between the upper bound of PCI and the observed value is used as the robust assessment score, as shown above in FIG. 3. The positivity and/or negativity (i.e., sign) of a robust assessment score from an observation can indicate whether the participants show a significant difference from control cohorts in the symptom assessed by the corresponding raw assessment score. A positive value sign indicates that the participant cannot be distinguished from controls. A negative value sign indicates that the participant can be distinguished from controls. The value zero (0) serves as a natural threshold for deciding the onset of a new symptom. Therefore, the robust assessment score can be used as a symptom onset indicator. Note that a robust assessment score can be generated from each raw assessment score. A robust assessment score assesses the same symptom as the symptom targeted by its corresponding raw assessment score. Multiple robust assessment scores together could be used to provide a comprehensive view of the progression pathway of the target disease. In some embodiments, robust assessment score component 123 can present data, results, and/or graphs, via UI 106.

An example of how disease progression component 121, control model generating component 122, and robust assessment score component operate is detailed in the following paragraphs. In this particular example, the integrated Huntington's Disease (HD) observational data was applied. In this example, the characteristics of the robust assessment scores uses two cognitive assessments: the Stroop Word Reading Test (SWRT) score and the Symbol Digit Modalities Test (SDMT) total correct score are demonstrated.

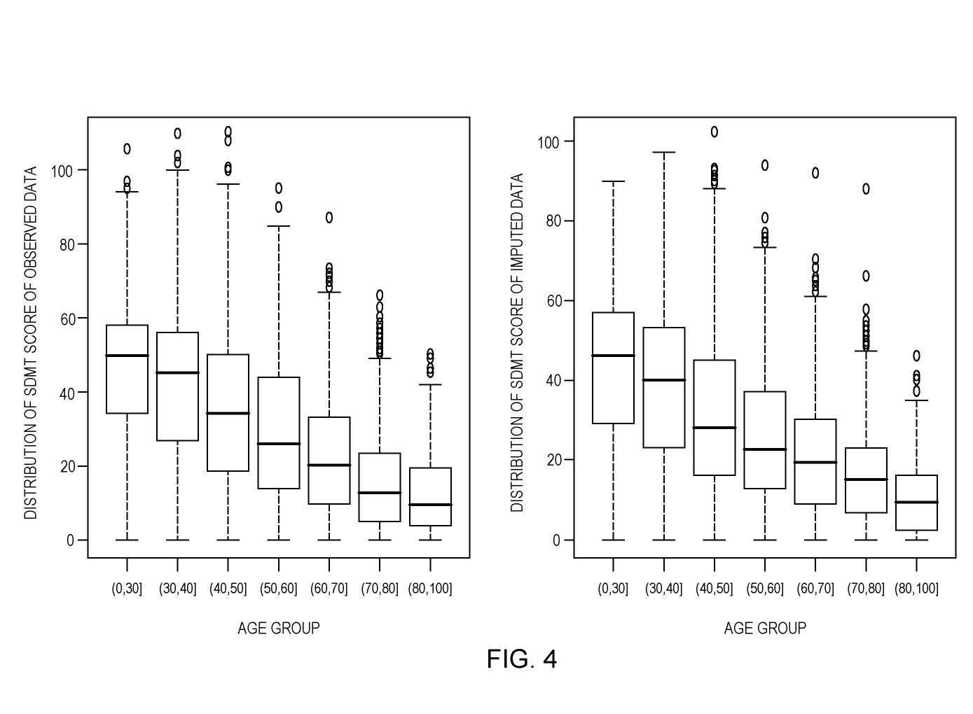

In this particular example a user selects to observe HD and enters HD data from a patient registry into disease progression component 121, via UI 106. Subsequent to retrieving patient registry data, in this particular example, control model generating component 122 receives the patient registry data and generates multiple complete data sets using the MI method. In this particular embodiment, control model generating component 122 enables the user to check the quality of the imputed data through UI 106. The imputed values can 1) have the same support as the observed data, and 2) have similar distributions as the observed data. In this particular example, control model generating component 122 applies the Predictive Mean Matching method during the MI step, therefore the imputed values were guaranteed to have the same support as the observed data. In this example, control model generating component 122 compares the distributions of the imputed values with the observed values. One example of the inspection is showed in FIG. 4. FIG. 4 is a boxplot graph illustrating imputed and observed SDMT scores in each age group. The left panel of FIG. 4 shows the distribution of observed SDMT scores in each age group, and the right panel shows the distribution of imputed SDMT scores in each age group. The plots demonstrate that the distributions of the imputed value are similar to that of the observed values. Similar inspections can be performed for observed and imputed values versus other factors. In other embodiments, a user can compare the distributions of the imputed values with the observed values by visual inspection.

After generating the ten sets of imputed data, control model generating component 122 creates control models for SDMT and SWRT separately on each complete data set. Patient characteristics, such as study ID, age, gender, and education levels, are used as predictors in the control models, in this particular example. For each assessment score on each imputed dataset, control model generating component 122 compares three types of candidate models (Generalized Linear Regression (GLM), Support Vector Machine (SVM) and Multivariate adaptive regression splines (MARS)). In this particular example, control model generating component 122 then selects the model with the highest R-squared value to create the control model on the imputed data set. A summary of the R-squared values from the selected models are listed in Table 1. In other embodiments, control model generating component 122 enables a user to select the model with the highest R-squared value to create the control model, via UI 106. After creating the control models, robust assessment score component 123 uses the bootstrap method to generate the 95% PCI for each case observation. Subsequent to generating the PCI, robust assessment score component 123 calculates the robust assessment scores for each complete dataset (see step 212). In the final step, robust assessment score component 123 aggregates the robust scores from the ten sets of complete data sets by calculating the mean values across the ten sets of complete data sets.

TABLE 1
Summary of selected model types and R-squares of
the control models.

| | Mean of R-squared | std. of R-squared |
|---|---|---|
| SDMT | 0.3994 | 3.46 × 10⁻⁵ |
| SWRT | 0.2519 | 1.68 × 10⁻⁵ |

In this particular example, subsequent to aggregating the robust scores the properties of the robust assessment scores are revealed. Values of raw assessment scores were not only influenced by HD disease status and progression, but also by other non-disease-related factors. The proposed method utilizes the control cohort to model and adjust the effect of non-disease-related factors. The robust assessment scores are expected to be less biased to the non-disease-related factors.

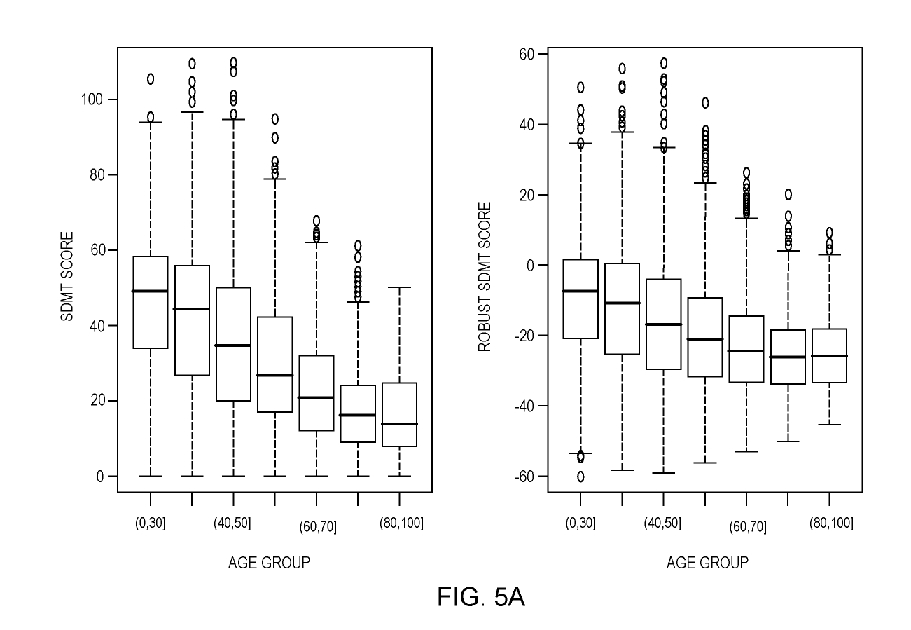

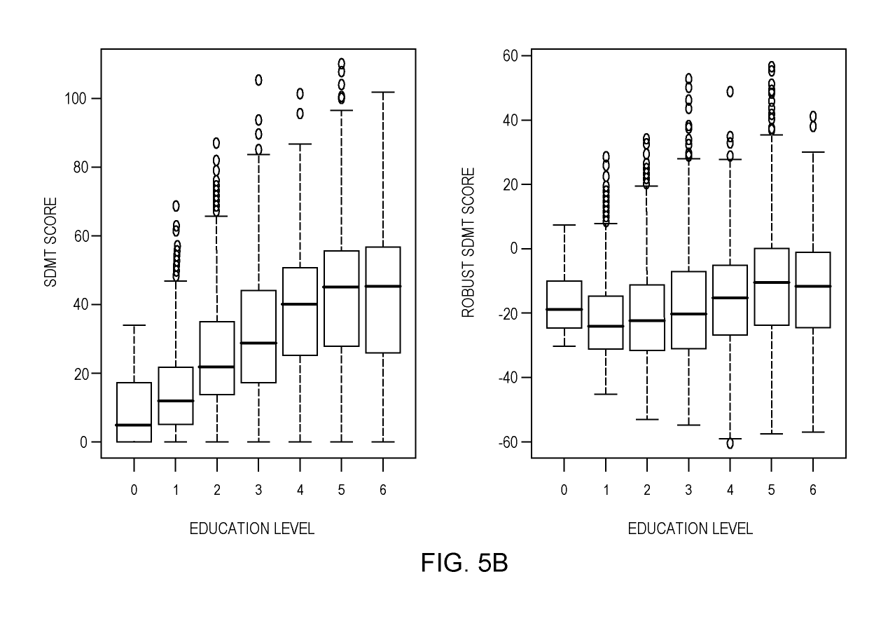

FIG. 5A and 5B are two boxplot examples that are comparing the distributions of raw and robust SDMT scores among the HDGECs versus two patient characteristics. In this particular example two patient characteristics are age groups and ISCED education levels. FIG. 5A is boxplot graphs displaying the Original and robust SDMT scores vs age groups, and FIG. 5B is boxplot graphs displaying the Original and adjusted SDMT scores vs ISCED education levels. The left panels show the distributions of the raw SDMT scores vs. age groups and ISCED education levels, respectively. The right panels show the distributions of the robust SDMT scores vs. age groups and ISCED education levels, respectively. The raw SDMT scores demonstrate strong correlation with age and education levels, while the robust SDMT scores demonstrate decreased correlation with the two factors. Table 2 summarizes the influences of non-disease-related factors in raw and robust SDMT/SWRT scores. For categorical factors, disease progression component 121 (i.e., robust assessment score component 123) calculates the average Cohan's d effective sizes of the scores between pairs of levels of the factor. For continuous factors, disease progression component 121 (i.e., robust assessment score component 123) reports the Spearman's correlation coefficients. A smaller average effective size or smaller absolute value of Spearman's correlation coefficient indicates decreased influence of the non-disease-related factor. Most non-disease-related factors show decreased influence in the robust scores. The few exceptions can be attributed to the imbalance of factors' effects in the control model. In general, the robust scores are less subject to changes in non-disease-related factors.

TABLE 2
Correlations and average effective sizes of raw and robust SDMT/SWRT scores with
patient characteristics.

| | | | | Education | | | Tobacco abuse | Drug abuse |
|---|---|---|---|---|---|---|---|---|
| | Study | Age | Marital Status | Level | Gender | Region | history | history |
| SMDT | 0.798 | −0.378 | 0.493 | 0.918 | 0.216 | 0.715 | 0.574 | 0.674 |
| Robust SDMT | 0.679 | −0.269 | 0.277 | 0.287 | 0.309 | 0.622 | 0.596 | 0.514 |
| SWRT | 0.793 | −0.320 | 0.438 | 0.902 | 0.169 | 0.653 | 0.660 | 0.636 |
| Robust SWRT | 0.587 | −0.280 | 0.254 | 0.250 | 0.129 | 0.795 | 0.511 | 0.407 |

The values of raw SDMT scores range from 0 to 120. The threshold values can distinguish normal vs. impaired cognitive abilities. A robust SDMT score comes with a natural threshold (i.e. zero) for deciding whether a HDGEC starts to show cognitive impairment. Since influences of the non-disease-related factors for the observation have been adjusted in the robust assessment score, the threshold is personalized and specific to HD. Similarly, a value of zero serves as a natural personalized threshold for other robust assessment scores to determine the onset of other symptoms in HDGECs. The ‘onset’, for a case participant, is being identified as a deviation from the model learned based on control participants.

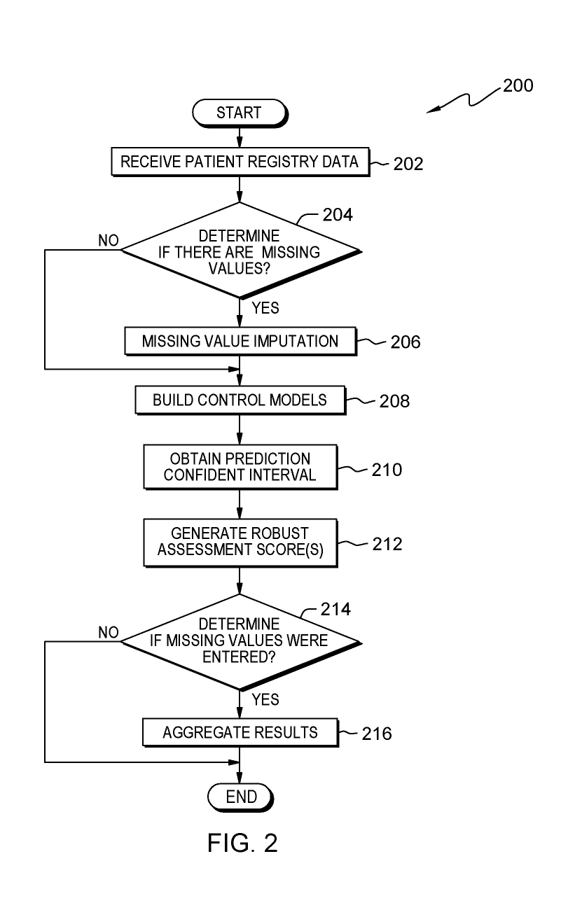

FIG. 2 is a flowchart depicting operational steps of disease progression component 121, on server computer 104 within distributed data processing environment 100 of FIG. 1, in accordance with an embodiment of the present invention. It should be appreciated that FIG. 2 provides only an illustration of one implementation and does not imply any limitations with regard to the environments in which different embodiments can be implemented. Many modifications to the depicted environment can be made.

In step 202, control model generating component 122 retrieves patient registry data. In various embodiments control model generating component 122 can request and retrieve data from database 124. In some embodiments a user can manually input data, via UI 106. In other embodiments, control model generating component 122 can present an option for a user to select filters in order to filter/narrow the selected data for analysis, via UI 106. For example, when a user accesses a patient registry a prompt will appear and ask the user which type of medical and/or disease data they would like to select for analysis. In this particular example, the user can select which disease and/or patient characteristics they are interested in examining. In another embodiment, the filter options can be displayed on a selection menu located on one of the edges of the data content.

In step 204, control model generating component 122 determines if there are missing values. In various embodiments, control model generating component 122 can determine if there are missing values from the patient registry data obtained and/or received from database 124. In some embodiments, if control model generating component 122 determines there are missing values in the received patient registry data control model generating component 122 can enable the user to manually input the missing data. In other embodiments, control model generating component 122 can perform a series of value imputations (step 206). The value imputation(s) can be automatic or can be entered manually by the user. In various embodiments, the value imputation can be influenced by the user's data interest and/or the selected data for analysis. In some embodiments, if control model generating component 122 determines there are no missing values in the patient registry data/data, then control model generating component 122 can begin to create control models (step 208). In some embodiments, control model generating component 122 can enable the user to skip the missing value imputation (step 206). In other embodiments, control model generating component 122 can enable the user to enter missing value imputation even if control model generating component 122 determines there are no missing values.

In step 206, control model generating component 122 performs missing value imputation. Imputation is the process of replacing missing data with substituted values. In various embodiments, control model generating component 122 can automatically input missing data/values and/or enable a user to manually enter and/or upload missing data/values through UI 106. In various embodiments, control model generating component 122 can perform Multiple Imputation (MI) with the Fully Conditional Specification method and Predictive Mean Matching to impute the missing values and generated multiple sets of complete data sets. Multiple Imputation is a statistical technique for analyzing incomplete data sets. Instead of filling in a single value for each missing value, MI procedure replaces each missing value with a set of plausible values. Uncertainty about the value to impute can be represented by the multiple imputed values. These multiple imputed data sets can be analyzed individually. Results from the multiple sets of complete data sets can then be aggregated to generate the final results. In some embodiments, control model generating component 122 can input at least one data/value, and/or enable a user to manually enter and/or upload at least one missing data/value through UI 106.

In step 208, control model generating component 122 can create control models. In various embodiments, control model generating component 122 can create control models based off the received patient registry data and/or the missing value imputation. In various embodiments, with each imputed data set, control model generating component 122 can create a model for a target assessment score using available patient characteristics as the predictors. In general, control model generating component 122 can create a model with high predictive power. For each target assessment score of interest on each imputed dataset, control model generating component 122 can compare multiple candidate predictive models, and choose the one with the highest predictive power (measured by R-squared) as the model of choice for the target assessment score on the imputed dataset. In various embodiments, control model generating component 122 can use different types of models as candidate control models such as: the generalized linear regression model, Support Vector Machines, and/or Multivariate adaptive regression splines. Control model generating component 122 is not limited to the three aforementioned types of models. Other types of prediction models known in the art can be used independently and/or in combination with other predictive models known in the art.

In step 210, robust assessment score component 123 generates prediction confident interval(s). In various embodiments, robust assessment score component 123 generates at least one prediction confident interval by transforming patient registry data into at least one prediction confident interval based on at least one control model built in step 208. In various embodiments, once a candidate model is selected as the control model for a target assessment score on the received patient registry data and/or an imputed data set, robust assessment score component 123 can generate predicted control values of the target assessment scores for the targeted disease on the received data set and/or the imputed data set. Robust assessment score component 123 can also generate the lower and upper bounds of the 95% confidence interval PCI for each case observation. For example, a user can use the bootstrap method to generate the PCI for case observations on each imputed dataset. Robust assessment score component 123 is not limited to using the bootstrap method, and can use any other method know in the art to generate the PCI.

In step 212, robust assessment score component 123 generates robust assessment scores. In various embodiments, robust assessment score component 123 can take the PCI generated from step 210 and transform the PCI into at least one robust assessment score. In other embodiments, robust assessment score component 123 can transform the PCI generated from step 210 into an interval estimate of what an assessment score would be for a hypothetical control participant with similar characteristics as a case participant. In various embodiments, if the observed assessment score of a case observation falls into the range of the PCI, then a participant has not shown significant difference from the control cohort(s) in the assessment score. On the other hand, in various embodiments, if the observed assessment score falls out of the range of the PCI, then a participant will show a significant difference from controls. The robust assessment score is calculated by subtracting the lower or upper bound of the PCI from the observed value. See FIG. 3. It should be noted that prediction confident interval(s) can include PCI data, results, and/or information.

In step 214, robust assessment score component 123 determines if missing values were entered. In various embodiments, robust assessment score component 123 can determine if missing values where entered into the patient registry data in order to complete the data set. In various embodiments, robust assessment score component 123 can communicate with control model generating component 122 to determine if missing values were entered. If robust assessment score component 123 determines missing values/data (i.e., new data) were entered into the received data (i.e., patient registry data), then robust assessment score component 123 can aggregate the results (step 216). If robust assessment score component 123 determines no missing values/data were entered into the received data (i.e., patient registry data), then robust assessment score component 123 can end the process.

In step 216, robust assessment score component 123 aggregates results. In various embodiments, robust assessment score component 123 can aggregate the generated robust assessment score(s). In some embodiments, robust assessment score component 123 can enable a user to take the average of the generated robust assessment scores and set it as the final robust assessment scores. In some embodiments, robust assessment score component 123 automatically sets the average of the generated robust assessment scores as the final robust assessment scores. In other embodiments, when there are no missing values/data in the observed data set (i.e., received patient registry data), step 216 can be skipped.

In step 218, robust assessment score component 123 outputs the robust assessment score. In various embodiments, robust assessment score component 123 can outputs the final robust assessment score, based on the average of the generated robust assessment scores. Robust assessment score component 123 can output the robust assessment score for disease progression indicator measurement.

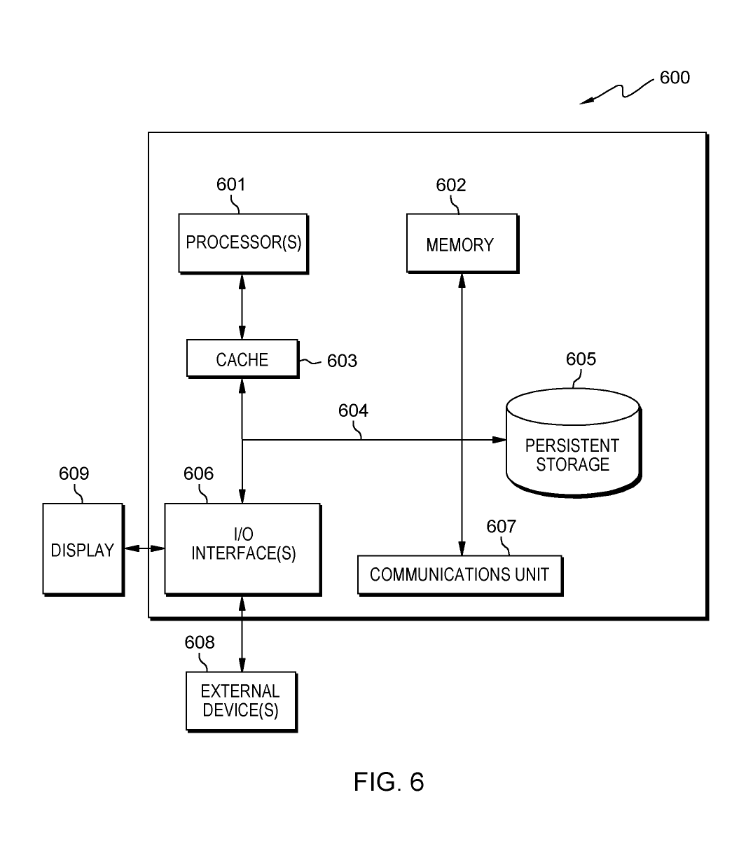

FIG. 6 depicts computer system 600, where server computer 120 represents an example of computer system 600 that includes disease progression component 121. The computer system includes processors 601, cache 603, memory 602, persistent storage 605, communications unit 607, input/output (I/O) interface(s) 606 and communications fabric 604. Communications fabric 604 provides communications between cache 603, memory 602, persistent storage 605, communications unit 607, and input/output (I/O) interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processors 601 by holding recently accessed data, and data near recently accessed data, from memory 602.

Program instructions and data used to practice embodiments of the present invention may be stored in persistent storage 605 and in memory 602 for execution by one or more of the respective processors 601 via cache 603. In an embodiment, persistent storage 605 includes a magnetic hard disk drive. Alternatively, or in addition to a magnetic hard disk drive, persistent storage 605 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605.

Communications unit 607, in these examples, provides for communications with other data processing systems or devices. In these examples, communications unit 607 includes one or more network interface cards. Communications unit 607 may provide communications through the use of either or both physical and wireless communications links. Program instructions and data used to practice embodiments of the present invention may be downloaded to persistent storage 605 through communications unit 607.

I/O interface(s) 606 enables for input and output of data with other devices that may be connected to each computer system. For example, I/O interface 606 may provide a connection to external devices 608 such as a keyboard, keypad, a touch screen, and/or some other suitable input device. External devices 608 can also include portable computer readable storage media such as, for example, thumb drives, portable optical or magnetic disks, and memory cards. Software and data used to practice embodiments of the present invention can be stored on such portable computer readable storage media and can be loaded onto persistent storage 605 via I/O interface(s) 606. I/O interface(s) 606 also connect to display 609.

Display 609 provides a mechanism to display data to a user and may be, for example, a computer monitor.

What is claimed is:

1. A computer-implemented method for generating a robust assessment score based on patient registry data for disease progression indicator measurement, the computer-implemented method comprising:
receiving, by one or more processors, patient registry data;
creating, by the one or more processors, at least one control model based on the patient registry data;
transforming, by the one or more processors, patient registry data into at least one prediction confident interval based on the at least one control model;
transforming, by the one or more processors, the at least one prediction confident interval into at least one robust assessment score; and
outputting, by the one or more processors, the at least one robust assessment score for measuring disease progression indicators.

2. The method of claim 1 further comprising:
determining, by the one or more processors, if there are missing values in the received patient registry data; and
responsive to determining if there are missing values in the received patient registry data, inputting, by the one or more processors, missing values.

3. The method of claim 2 further comprising:
determining, by the one or more processors, if missing values were inputted; and
responsive to determining if the missing values where inputted, aggregating, by the one or more processors, the at least one robust assessment score.

4. The method of claim 1, wherein creating the at least one control model comprises:
comparing, by the one or more processors, at least two predictive models; and
selecting, by the one or more processors, the predictive model with the highest predicted power as the model for a target assessment score.

5. The method of claim 1, wherein the robust assessment score comprises a value that is positive, negative, or zero;
wherein the positive value indicates that a participant cannot be distinguished from controls;
wherein the negative value indicates that the participant can be distinguished from controls; and
wherein the value of zero serves as a natural threshold for deciding the onset of a new symptom.

6. The method of claim 1, wherein the creating of control models comprises missing value imputation.

7. The method of claim 1, wherein patient registry data comprises at least one of: age, gender, heritage, language, social cues, demographic, occupation, medical history, blood type, patient medical records, pain thresholds, geographical region, psychological level, mental health, nationality, family medical history, genotype of a patient, genotype of a disease, phenotypical characteristics of a disease, genealogy of a patient, genealogy of a disease, natural history data of a disease, natural history data of a diseases mutation carriers, disease symptoms, and disease characteristics.

8. A computer program product for generating a robust assessment score based on patient registry data for disease progression indicator measurement, the computer program product comprising:
one or more computer readable storage devices and program instructions stored on the one or more computer readable storage devices, the stored program instructions comprising:
program instructions to receive patient registry data;
program instructions to create at least one control model based on the patient registry data;
program instructions to transform patient registry data into at least one prediction confident interval based on the at least one control model;
program instructions to transform the at least one prediction confident interval into at least one robust assessment score; and
program instructions to output the at least one robust assessment score for measuring disease progression indicators.

9. The computer program product of claim 8 further comprising:
program instructions to determine if there are missing values in the received patient registry data; and
responsive to determining if there are missing values in the received patient registry data, program instructions to input missing values.

10. The computer program product of claim 9 further comprising:
program instructions to determine if missing values were inputted; and
responsive to determining if the missing values where inputted, aggregating, by the one or more processors, the at least one robust assessment score.

11. The computer program product of claim 8, wherein creating the at least one control model comprises:
program instructions to compare at least two predictive models; and
program instructions to select the predictive model with the highest predicted power as the model for a target assessment score.

12. The computer program product of claim 8, wherein the robust assessment score comprises a value that is positive, negative, or zero;
wherein the positive value indicates that a participant cannot be distinguished from controls;
wherein the negative value indicates that the participant can be distinguished from controls; and
wherein the value of zero serves as a natural threshold for deciding the onset of a new symptom.

13. The computer program product of claim 8, wherein the creating of control models comprises missing value imputation.

14. The computer program product of claim 8, wherein patient registry data comprises at least one of: age, gender, heritage, language, social cues, demographic, occupation, medical history, blood type, patient medical records, pain thresholds, geographical region, psychological level, mental health, nationality, family medical history, genotype of a patient, genotype of a disease, phenotypical characteristics of a disease, genealogy of a patient, genealogy of a disease, natural history data of a disease, natural history data of a diseases mutation carriers, disease symptoms, and disease characteristics.

15. A computer system comprising:
one or more computer processors;
one or more computer readable storage devices;
program instructions stored on the one or more computer readable storage devices for execution by at least one of the one or more computer processors, the stored program instructions comprising:
program instructions to receive patient registry data;
program instructions to create at least one control model based on the patient registry data;
program instructions to transform patient registry data into at least one prediction confident interval based on the at least one control model;
program instructions to transform the at least one prediction confident interval into at least one robust assessment score; and
program instructions to output the at least one robust assessment score for measuring disease progression indicators.

16. The computer system of claim 15 further comprising:
program instructions to determine if there are missing values in the received patient registry data; and
responsive to determining if there are missing values in the received patient registry data, program instructions to input missing values.

17. The computer system of claim 16 further comprising:
program instructions to determine if missing values were inputted; and
responsive to determining if the missing values where inputted, aggregating, by the one or more processors, the at least one robust assessment score.

18. The computer system of claim 15, wherein creating the at least one control model comprises:
program instructions to compare at least two predictive models; and
program instructions to select the predictive model with the highest predicted power as the model for a target assessment score.

19. The computer system of claim 15, wherein the robust assessment score comprises a value that is positive, negative, or zero;
wherein the positive value indicates that a participant cannot be distinguished from controls;
wherein the negative value indicates that the participant can be distinguished from controls; and
wherein the value of zero serves as a natural threshold for deciding the onset of a new symptom.

20. The computer system of claim 15, wherein patient registry data comprises at least one of: age, gender, heritage, language, social cues, demographic, occupation, medical history, blood type, patient medical records, pain thresholds, geographical region, psychological level, mental health, nationality, family medical history, genotype of a patient, genotype of a disease, phenotypical characteristics of a disease, genealogy of a patient, genealogy of a disease, natural history data of a disease, natural history data of a diseases mutation carriers, disease symptoms, and disease characteristics.
